(19) United States
(12) Patent Application Publication
(10) Pub. No.: US 2015/0295874 A1
(43) Pub. Date: Oct. 15, 2015

(54) MESSAGE PRELOADING SYSTEM

(71) Applicant: Nokia Technologies Oy, Espoo (FI)

(72) Inventors: Otso Virtanen, Helsinki (FI); Eric Lajeunesse, Saint-Hubert (CA)

(73) Assignee: Nokia Technologies Oy, Espoo (FI)

(21) Appl. No.: 14/437,994

(22) PCT Filed: Dec. 17, 2012
(86) PCT No.: PCT/CN2012/086737

§ 371 Date: Apr. 23, 2015

(51) Int. Cl. H04L 12/58

(52) U.S. Cl. CPC H04L 51/18; H04L 51/08

(57) ABSTRACT

A method comprising: obtaining, by a client application of a messaging system, information about messages of a user residing on a messaging server; obtaining at least message headers for previously not downloaded messages; determining, on a basis of at least one predefined rule, whether to download whole content of at least one previously not downloaded message in the client application; and downloading the messages for which a positive download decision is made in the client application.

### BACKGROUND

Various messaging applications are based on a client-server approach, where a client application is installed on an end-user device and a server application installed on a messaging server in the network is responsible for delivering messages to and from the client application of the end-user device. In many messaging applications, such as in email applications, it is common to either download by the client application, or alternatively push by the server application, a list of email headers to be visualized in the messaging inbox of the end-user device, and wait for the end user selection before downloading content. In some applications, the client application may directly download all the new messages received and their content.

The direct downloading of all new messages may raise a problem for memory constraint, typically portable end-user devices: if the user is not interested in opening all of the unread messages, downloading all the unread messages and their content unnecessarily consumes the memory space of the end-user device and uses data connection resources.

On the other hand, if only the headers of the messages are downloaded or pushed to the end-user device, each of the messages selected by the user for opening need to be downloaded separately, possibly over a slow communication link, which may result in additional wait time for the user and thus an unpleasant user experience.

Therefore, there is a need for a more optimised procedure for downloading messages.

### SUMMARY

Now there has been invented an improved method and technical equipment implementing the method for at least alleviating the problems. Various aspects of the invention include a method, apparatuses and computer programs, which are characterized by what is stated in the independent claims. Various embodiments of the invention are disclosed in the dependent claims.

According to a first aspect, there is provided a method comprising: obtaining, by a client application of a messaging system, information about messages of a user residing on a messaging server; obtaining at least message headers for previously not downloaded messages; determining, on a basis of at least one predefined rule, whether to download whole content of at least one previously not downloaded message in the client application; and downloading the messages for which a positive download decision is made in the client application.

According to an embodiment, the method further comprises deriving the at least one predefined rule for determining whether to download the whole content of the message on the basis of one or more of the following pieces of information:
a previous decision to read/not read a message from a contact
the contact existing/not existing in a local address book of the end-user device
a number of previous messages to/from the contact
time and date of a message delivery
a location of the user
any previous message in a same thread
any attachments in the message
the subject of the message
possible importance/X-Priority fields included in the message.

According to an embodiment, said at least one predefined rule is based on at least previous decisions to read/not read a message from the contact.

According to an embodiment, the method further comprises maintaining a contact-specific lookup table for received and opened messages; updating the lookup table for each of the received new messages of the particular contact; and making a decision to download the whole content of the message on the basis of a proportion of opened messages from all the received messages of said contact.

According to an embodiment, the method further comprises making a decision to download the whole content of the message if the proportion of the opened messages from all the received messages of said contact is above a download decision threshold.

According to an embodiment, the method further comprises, in response to receiving a message from a new contact not included in the lookup table, removing a least recently used contact from the lookup table; and including the new contact in the lookup table.

According to an embodiment, the method further comprises excluding contacts from which messages are most probably downloaded from the process of removing the least recently used contact from the lookup table.

According to an embodiment, the method further comprises, in response to removing a message, which has been preloaded in the client application but not opened by the user, from the client application, deducting a penalty from the proportion of the opened messages of the contact sending the message.

According to an embodiment, the method further comprises, in response to the user downloading a message, which has not been preloaded in the client application, adding a compensation to the proportion of the opened messages of the contact sending the message.

According to a second aspect, there is provided an apparatus comprising at least one processor, memory including computer program code, the memory and the computer program code configured to, with the at least one processor, cause the apparatus to at least: obtain, by a client application of a messaging system, information about messages of a user residing on a messaging server; obtain at least message headers for previously not downloaded messages; determine, on a basis of at least one predefined rule, whether to download whole content of at least one previously not downloaded message in the client application; and download the messages for which a positive download decision is made in the client application.

According to a third aspect, there is provided a computer program embodied on a non-transitory computer readable medium, the computer program comprising instructions causing, when executed on at least one processor, at least one apparatus to: obtain, by a client application of a messaging system, information about messages of a user residing on a messaging server; obtain at least message headers for previously not downloaded messages; determine, on a basis of at least one predefined rule, whether to download whole content of at least one previously not downloaded message in the client application; and download the messages for which a positive download decision is made in the client application.

According to a fourth aspect, there is provided an apparatus comprising: means for obtaining, by a client application of a messaging system, information about messages of a user residing on a messaging server; means for obtaining at least message headers for previously not downloaded messages; means for determining, on a basis of at least one predefined rule, whether to download whole content of at least one previously not downloaded message in the client application; and means for downloading the messages for which a positive download decision is made in the client application.

These and other aspects of the invention and the embodiments related thereto will become apparent in view of the detailed disclosure of the embodiments further below.

### LIST OF DRAWINGS

In the following, various embodiments of the invention will be described in more detail with reference to the appended drawings, in which

FIGS. 1a and 1b show a system and devices suitable to be used in a messaging system according to an embodiment; and

FIG. 2 shows a flow chart of a messaging method according to an embodiment.

### DESCRIPTION OF EMBODIMENTS

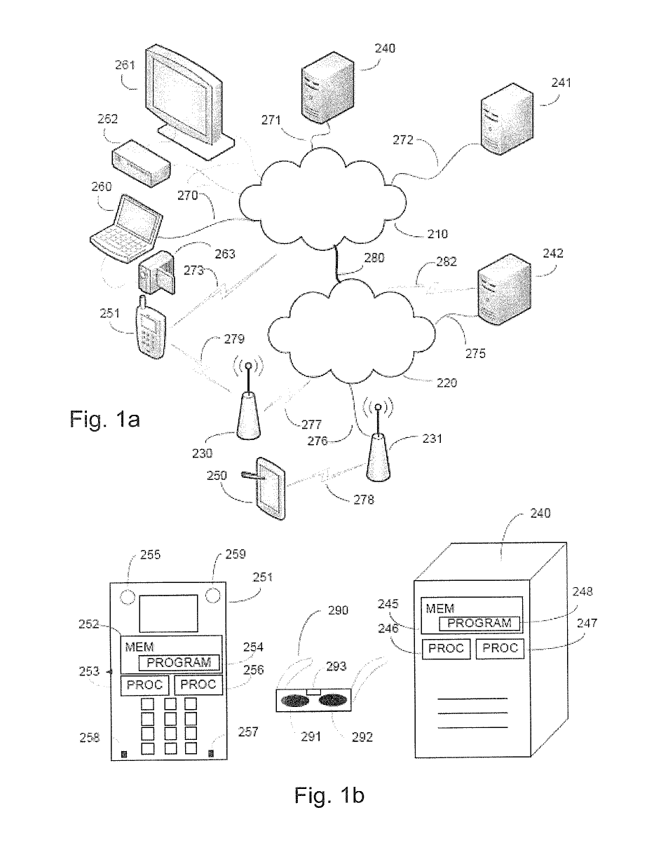

FIGS. 1a and 1b show a system and devices suitable to be used in a messaging system according to an embodiment. In FIG. 1a, the different devices may be connected via a fixed network 210 such as the Internet or a local area network; or a mobile communication network 220 such as the Global System for Mobile communications (GSM) network, 3rd Generation (3G) network, 3.5th Generation (3.5G) network, 4th Generation (4G) network, Wireless Local Area Network (WLAN), Bluetooth®, or other contemporary and future networks. Different networks are connected to each other by means of a communication interface 280. The networks comprise network elements such as routers and switches to handle data (not shown), and communication interfaces such as the base stations 230 and 231 in order for providing access for the different devices to the network, and the base stations 230, 231 are themselves connected to the mobile network 220 via a fixed connection 276 or a wireless connection 277.

There may be a number of servers connected to the network, and in the example of FIG. 1a are shown servers 240, 241 and 242, each connected to the mobile network 220, which servers may be arranged to operate as computing nodes (i.e. to form a cluster of computing nodes or a so-called server farm) for the messaging system. The servers may be messaging servers of any type of messaging system, such as email system, social media applications, instant messaging applications etc. Some of the above devices, for example the computers 240, 241, 242 may be such that they are arranged to make up a connection to the Internet with the communication elements residing in the fixed network 210.

There are also a number of end-user devices such as mobile phones and smart phones 251, Internet access devices (Internet tablets) 250, personal computers 260 of various sizes and formats, televisions and other viewing devices 261, video decoders and players 262, as well as video cameras 263 and other encoders. These devices 250, 251, 260, 261, 262 and 263 can also be made of multiple parts. The various devices may be connected to the networks 210 and 220 via communication connections such as a fixed connection 270, 271, 272 and 280 to the Internet, a wireless connection 273 to the internet 210, a fixed connection 275 to the mobile network 220, and a wireless connection 278, 279 and 282 to the mobile network 220. The connections 271-282 are implemented by means of communication interfaces at the respective ends of the communication connection.

FIG. 1b shows devices for a messaging system according to an example embodiment. As shown in FIG. 1b, the server 240 contains memory 245, one or more processors 246, 247, and computer program code 248 residing in the memory 245 for implementing, for example, a messaging system. The different servers 241, 242, 290 may contain at least these elements for employing functionality relevant to each server.

Similarly, the end-user device 251 contains memory 252, at least one processor 253 and 256, and computer program code 254 residing in the memory 252 for implementing, for example, gesture recognition. The end-user device may also have one or more cameras 255 and 259 for capturing image data, for example stereo video. The end-user device may also contain one, two or more microphones 257 and 258 for capturing sound. The different end-user devices 250, 260 may contain at least these same elements for employing functionality relevant to each device.

The end user devices may also comprise a screen for viewing single-view, stereoscopic (2-view), or multiview (more-than-2-view) images. The end-user devices may also be connected to video glasses 290 e.g. by means of a communication block 293 able to receive and/or transmit information. The glasses may contain separate eye elements 291 and 292 for the left and right eye.

It needs to be understood that different embodiments allow different parts to be carried out in different elements. For example, parallelized processes of the messaging system may be carried out in one or more network devices 240, 241, 242, 290. The elements of the messaging system may be implemented as a software component residing on one device or distributed across several devices, as mentioned above, for example so that the devices form a so-called cloud.

The embodiments may be implemented in various kinds of client-server messaging systems. For example, email applications using e.g. POP3-based (Post Office Protocol, version 3) or IMAP-based (Internet Message Access Protocol) clients may be utilized in the embodiments. Furthermore, various kinds of social media applications, such as Twitter® clients or Facebook® service clients, may be arranged to operate according to the embodiments.

In the client-server messaging systems a client application is installed on the end-user device and a server application installed on the messaging server in the network is responsible for delivering messages to and from the client application of the end-user device. When the user receives a new message in the messaging system, either by the client application downloads, or alternatively the server application pushes, a list of message headers to be visualized in the messaging inbox of the end-user device. The end user may then select the messages he/she wants to download. In some applications, the client application may directly download all the new messages received and their content.

The direct downloading of all new messages may raise a problem for memory constraint, typically portable end-user devices: if the user is not interested in opening all of the unread messages, downloading all the unread messages and their content unnecessarily consumes the memory space of the end-user device and uses data connection resources.

On the other hand, if only the headers of the messages are downloaded or pushed to the end-user device, each of the messages selected by the user for opening need to be downloaded separately, possibly over a slow communication link, which may result in additional time of waiting for the user.

The problem can be summarized such that there is no foreknowledge of which messages the user would want to particularly download before the user actually initiates the download.

In order to alleviate these problems, a new method for selecting a subset of received messages to be preloaded in the client application is presented herein. The method utilizes various pieces of message-related information and/or contact (i.e. sender)-related information for creating at least one predefined rule for determining whether to download the whole content of the message. It is noted that the message content may include a message e.g. in a text format and/or one or more attachments, e.g. in a file format or as logical links to further content.

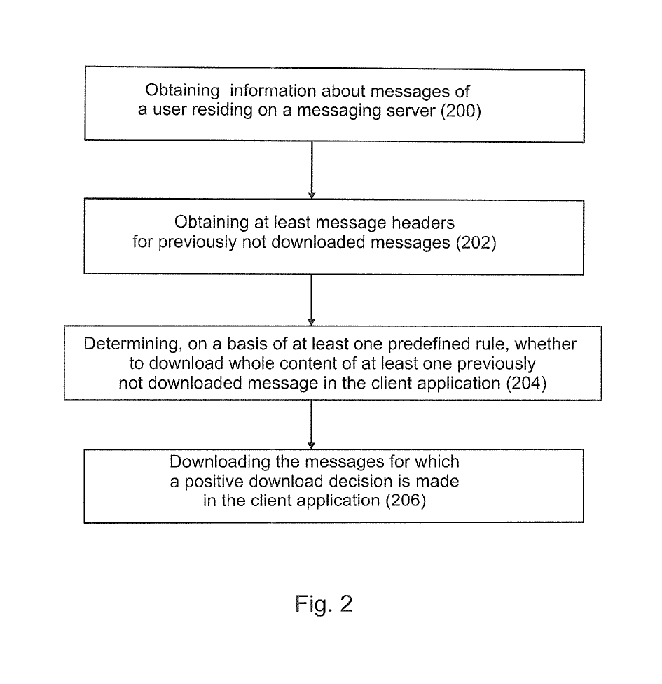

A method according to a first aspect and various embodiments related thereto are now described by referring to the flow chart of FIG. 2 describing the operation of the client application. First, the client application obtains information about messages of the user residing on a messaging server (200). In other words, either the client application requests from the messaging server a list of messages in the user's mailbox or the server applications pushes the list to the client. For all unseen (i.e. previously not downloaded) messages, at least message headers are obtained (202) in the client applications. Again, the headers may be downloaded by the client or pushed by the server.

According to an embodiment, in addition to message headers, at least one fine (e.g. the first line) of message content is also obtained. For example, if a TOP command is supported by the messaging server, such as a POP3 messaging server, the client may send a “TOP 1 1” command to the server, whereupon the server responds by sending the header of message “1”, a blank line, and the first line of the body of the message.

Then for the unseen messages, it is determined (204), on the basis of at least one predefined rule, whether to download the whole content of the message in the client application. Finally, the messages, for which a positive download decision is made, are downloaded (206) in the client application.

According to an embodiment, the at least one predefined rule for determining whether to download the whole content of the message is derived on the basis of one or more of the following pieces of information:
a previous decision to read/not read a message from the contact (i.e. the sender)
the contact existing/not existing in a local address book of the end-user device
the number of previous messages to/from the contact
time and date of the message delivery
the location of the user
any previous message in the same thread?
any attachments in the message?
the subject of the message
possible importance/X-Priority fields included in the message

According to an embodiment, said at least one predefined rule may be based on previous decisions to read/not read a message from the contact. The decision-making of whether the message is considered interesting may be carried out as follows:

A contact-specific lookup table (size n contacts) for the received and opened messages is maintained by the client. Then for each of the received new messages, the lookup table is updated as regards to the received messages of the particular contact, and on the basis of the proportion of opened messages from all the received messages of said contact a decision can be made to download the whole content of the message. Table 1 shows an example of the look-up table.

TABLE 1

| | Received | Opened | | |
|---|---|---|---|---|
| Contact | msg # | msg # | % | Download? |
| a@foo.com | 10 | 5 | 50 | YES |
| b@foo.com | 10 | 0 | 0 | NO |
| c@foo.com | 10 | 10 | 100 | YES |
| . . . | | | | |

The positive download decision may be made, if the proportion is, for example, over a download decision threshold of 10% or 20% or 30% or 40% or at least 50%. The size of the lookup table may be limited to, for example, 100 contacts (n=100). Thus, the space required for the lookup table is known beforehand.

The above embodiment may be further adjusted such that the list of contacts is continuously updated such that the oldest contacts are dropped from the lookup table, when new messages are received from new contacts. The number of contacts in the lookup table may be kept constant, e.g. n=100, which results in a lookup table of a feasible size of roughly 6.5 kB. Table 2 shows an example of the look-up table.

TABLE 2

| | Last msg | Received | Opened | | |
|---|---|---|---|---|---|
| Contact | received | msg # | msg # | % | Download? |
| a@foo.com | 1.1.2012 | 10 | 5 | 50 | YES |
| b@foo.com | 1.1.2011 | 10 | 0 | 0 | NO |
| c@foo.com | 1.12.2010 | 10 | 10 | 100 | YES |
| . . . | | | | | |

The lookup table is adjusted by a further column including the date of the latest message received from each of the contact. When a message is received from a new contact not included in the lookup table, the oldest (Least Recently Used, LRU) contact is dropped from the lookup table and the new contact is included in the lookup table. Otherwise, the conditions to make a download decision may be the same as in the above embodiment.

According to an embodiment, the contacts from which messages are most probably downloaded are excluded from the process of dropping the oldest contacts from the lookup table. In other words, if the proportion of the opened messages from all the received messages of said contact is high enough, say at least 80%, said contact is not removed from the lookup table even if the date of the latest message received from said contact were the oldest in the lookup table. For example, in table 2 the contact “c@foo.com” having the proportion of the opened messages as 100% would not be removed from the lookup table despite of having the oldest date of the latest message received. Thus, as long as the proportion of the opened messages of a contact remains above a predetermined threshold, for example above 80%, such contact remains a permanent member of the lookup table.

The above embodiments may be further adjusted to be adaptive such that a penalty caused by wrong preload decisions is deducted from the proportion of the opened messages. An end-user device typically comprises a message cache memory, wherein the messages are preloaded before they are opened by the client application according to the user commands. The client application may be arranged to maintain a second table for observing whether the messages preloaded in the cache have been viewed by the user. Table 3 shows an example of such table.

TABLE 3

| Message | Preloaded in | |
|---|---|---|
| number #/id | the cache | Viewed |
| 1 | NO | NO |
| 2 | YES | NO |
| 3 | YES | NO |
| 4 | NO | NO |
| 5 | NO | YES |
| 6 | YES | YES |

When the message cache becomes full, any new incoming message may cause the oldest messages to be removed from the cache. On the other hand, the cache may be provided with a timer for configuring a maximum storage time for each message; when the maximum storage time expires, the message is removed from the cache.

Now when a message, which has been preloaded in the cache but not opened by the user, is removed from the cache, a predetermined penalty of x percent is deducted from the proportion of the opened messages of the contact in question. For example, the removal of the unopened messages #2 and #3 in Table 3 would cause a penalty subtraction from the proportion of the opened messages of the contact(s) that has sent the messages #2 and #3.

As opposed to the penalty for preloading a message which is removed as unopened, it is also possible to provide positive compensation when a non-preloaded message is nevertheless downloaded by the user. For example, the message #5 in Table 3 was not preloaded but it was nevertheless downloaded and opened by the user. In such a case, a predetermined compensation of y percent is added to the proportion of the opened messages of the contact in question.

It is noted that while the “Preloaded in the cache” column is not necessary for assigning the penalties, because the information is obtainable from the message database in the server, it is beneficial to be maintained by the client application for making the comparisons necessary for assigning the positive compensations.

According to an embodiment, the client application may be provided with a setting for switching the above-described preloading features on or off, thus providing the user with a possibility to choose if he/she wants to utilize the features. According to an embodiment, the user may be provided with a possibility to adjust the download decision threshold for example by a slider on the application user interface, where one end of the slider represents faster message preload (e.g. a threshold of 10%) and the other end of the slider represents slower message preload (e.g. a threshold of 60% or 70% or 80%). Any value of the threshold there between may be selected by the slider.

The download decision threshold may also be automatically adaptive, for example, as a function of a number of received messages and/or the date of the latest message received and/or the proportion of the opened messages from all the received messages. The adaptation may be carried out as contact-specifically or as common to all contacts.

In addition to, or instead of, the possibility to adjust the download decision threshold, the user may also be provided with a possibility to adjust the amount of the penalty and/or the positive compensation to be e.g. contact-dependent.

There can be huge variations in the number of messages received by different users. Therefore, according to an embodiment, the maximum storage time for each message can be automatically adaptive based on the frequency of new messages arriving to the device or it can be adjustable by the user. Furthermore, while the maximum size of the message cache is device-dependent, it may be possible for the user to adjust the size to be smaller.

The above embodiments describe various combinations for utilizing a previous decision to read/not read a message from the contact, the number of previous messages to/from the contact and time and date of the message delivery when deciding whether to preload a message. However, any other piece of information listed above may be utilized, instead of or in addition to the above embodiments, for deciding whether to preload a message.

According to an embodiment, small messages with a size under a predefined threshold, such as 20 kB, may always be preloaded.

According to an embodiment, messages with data indicating certain type of priority, such as “Importance” value set to “High” or previous messages in the same message thread, may always be preloaded.

As mentioned above, the embodiments may be implemented in various kinds of client-server messaging systems. For example, a Twitter client may use the same mechanisms to optimally preload e.g. images and other multimedia content included in the tweets.

In the server-client interaction, both the server and the client may adjust their lookup tables where necessary. Thus, the user interactions via other means, such as a web browser, may be replicated to the client side.

According to an embodiment, the contact-specific lookup tables described above may be implemented as common to all types of messaging applications, such as emails, social media applications, instant messaging application, etc. Accordingly, a message from any of these applications has an adjusting effect for rules of preloading a message for the particular client.

A skilled man appreciates that any of the embodiments described above may be implemented as a combination with one or more of the other embodiments, unless there is explicitly or implicitly stated that certain embodiments are only alternatives to each other.

The various embodiments may provide advantages over the state of the art. For example, the time of waiting when the user opens messages and other content items originating from remote service may be minimized, thus resulting in a more satisfying user experience. Using the predefined rules results in preloading only messages that are at least potentially relevant for the user. This reduces the downloading of non-relevant messages, when compared to the case of downloading all unread messages.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, or CD.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

1-36. (canceled)

37. A method comprising:
obtaining, by a client application of a messaging system, information about messages of a user residing on a messaging server;
obtaining at least message headers for previously not downloaded messages;
determining, on a basis of at least one predefined rule, whether to download whole content of at least one previously not downloaded message in the client application; and
downloading the messages for which a positive download decision is made in the client application.

38. A method of claim 37, further comprising
deriving the at least one predefined rule for determining whether to download the whole content of the message on the basis of one or more of the following pieces of information:
a previous decision to read/not read a message from a contact;
the contact existing/not existing in a local address book of the end-user device;
a number of previous messages to/from the contact;
time and date of a message deliver;
a location of the user;
any previous message in a same thread;
any attachments in the message;
the subject of the message, and
possible importance/X-Priority fields included in the message.

39. A method of claim 37, wherein said at least one predefined rule is based on at least previous decisions to read/not read a message from the contact.

40. A method of claim 39, further comprising
maintaining a contact-specific lookup table for received and opened messages;
updating the lookup table for each of the received new messages of the particular contact; and
making a decision to download the whole content of the message on the basis of a proportion of opened messages from all the received messages of said contact.

41. A method of claim 40, further comprising
making a decision to download the whole content of the message if the proportion of the opened messages from all the received messages of said contact is above a download decision threshold.

42. A method of claim 40, further comprising
in response to receiving a message from a new contact not included in the lookup table, removing a least recently used contact from the lookup table; and
including the new contact in the lookup table.

43. A method of claim 42, further comprising
excluding contacts from which messages are most probably downloaded from the process of removing the least recently used contact from the lookup table.

44. A method of claim 40, further comprising
in response to removing a message, which has been preloaded in the client application but not opened by the user, from the client application, deducting a penalty from the proportion of the opened messages of the contact sending the message.

45. A method of claim 40, further comprising
in response to the user downloading a message, which has not been preloaded in the client application, adding a compensation to the proportion of the opened messages of the contact sending the message.

46. An apparatus comprising at least one processor, memory including computer program code, the memory and the computer program code configured to, with the at least one processor, cause the apparatus to at least:
obtain, by a client application of a messaging system, information about messages of a user residing on a messaging server;
obtain at least message headers for previously not downloaded messages;
determine, on a basis of at least one predefined rule, whether to download whole content of at least one previously not downloaded message in the client application; and
download the messages for which a positive download decision is made in the client application.

47. An apparatus of claim 46, further comprising computer program code configured to, with the at least one processor, cause the apparatus to at least:
derive the at least one predefined rule for determining whether to download the whole content of the message on the basis of one or more of the following pieces of information:
a previous decision to read/not read a message from a contact;
the contact existing/not existing in a local address book of the end-user device;
a number of previous messages to/from the contact;
time and date of a message delivery;
a location of the user;
any previous message in a same thread;
any attachments in the message;
the subject of the message, and
possible importance/X-Priority fields included in the message.

48. An apparatus of claim 46, wherein said at least one predefined rule is based on at least previous decisions to read/not read a message from the contact.

49. An apparatus of claim 48, further comprising computer program code configured to, with the at least one processor, cause the apparatus to at least
maintain a contact-specific lookup table for received and opened messages;
update the lookup table for each of the received new messages of the particular contact; and
make a decision to download the whole content of the message on the basis of a proportion of opened messages from all the received messages of said contact.

50. An apparatus of claim 49, further comprising computer program code configured to, with the at least one processor, cause the apparatus to at least
make a decision to download the whole content of the message if the proportion of the opened messages from all the received messages of said contact is above a download decision threshold.

51. An apparatus of claim 49, further comprising computer program code configured to, with the at least one processor, cause the apparatus to at least
remove, in response to receiving a message from a new contact not included in the lookup table, a least recently used contact from the lookup table; and
include the new contact in the lookup table.

52. An apparatus of claim 51, further comprising computer program code configured to, with the at least one processor, cause the apparatus to at least
exclude contacts from which messages are most probably downloaded from the process of removing the least recently used contact from the lookup table.

53. An apparatus of claim 49, further comprising computer program code configured to, with the at least one processor, cause the apparatus to at least
deduct, in response to removing a message, which has been preloaded in the client application but not opened by the user, from the client application, a penalty from the proportion of the opened messages of the contact sending the message.

54. An apparatus of claim 49, further comprising computer program code configured to, with the at least one processor, cause the apparatus to at least
add, in response to the user downloading a message, which has not been preloaded in the client application, a compensation to the proportion of the opened messages of the contact sending the message.

55. A computer program embodied on a non-transitory computer readable medium, the computer program comprising instructions causing, when executed on at least one processor, at least one apparatus to:
obtain, by a client application of a messaging system, information about messages of a user residing on a messaging server;
obtain at least message headers for previously not downloaded messages;
determine, on a basis of at least one predefined rule, whether to download whole content of at least one previously not downloaded message in the client application; and
download the messages for which a positive download decision is made in the client application.

56. A computer program of claim 55, further comprising computer program code configured to, with the at least one processor, cause the apparatus to at least:
derive the at least one predefined rule for determining whether to download the whole content of the message on the basis of one or more of the following pieces of information:
a previous decision to read/not read a message from a contact;
the contact existing/not existing in a local address book of the end-user device;
a number of previous messages to/from the contact;
time and date of a message delivery;
a location of the user;
any previous message in a same thread;
any attachments in the message;
the subject of the message; and
possible importance/X-Priority fields included in the message.
